(19) United States
(12) Patent Application Publication
(10) Pub. No.: US 2026/0313210 A1
(43) Pub. Date: Oct. 8, 2026

(54) CAMERA UNIT

(71) Applicant: Mitsubishi Electric Mobility Corporation, Tokyo (JP)

(72) Inventor: Akito IWAI, Tokyo (JP)

(73) Assignee: Mitsubishi Electric Mobility Corporation, Tokyo (JP)

(21) Appl. No.: 19/108,371

(22) PCT Filed: Nov. 16, 2022
(86) PCT No.: PCT/JP2022/042494

§ 371 Date: Mar. 3, 2025

(51) Int. Cl. H04N 23/52; G06V 20/59; H04N 23/51; H04N 23/54; H04N 23/57

(52) U.S. Cl. CPC H04N 23/52; H04N 23/51; H04N 23/54; H04N 23/57; G06V 20/597

(57) ABSTRACT

An object of a technique according to the present disclosure is to provide an in-vehicle camera unit capable of being downsized. The camera unit according to the present disclosure includes a rigid flexible substrate and a holder. The holder is a single component directly fixing the rigid flexible substrate and an outermost component of the camera unit. A plurality of substrates constituting the rigid flexible substrate include an imaging substrate mounting a light-receiving element of the camera and a transmission substrate mounting an external output connector for connecting the rigid flexible substrate to an outer part of the camera unit. The holder fixes the imaging substrate and the transmission substrate to be directed to directions different from each other. The light-receiving element and the external output connector are exposed to directions different from each other from the holder while the rigid flexible substrate is fixed to the holder.

### TECHNICAL FIELD

The present disclosure relates to a camera unit.

### BACKGROUND ART

Recently, a downsized camera unit is required as a constituent element of a driver monitoring system of monitoring a state of a driver of a vehicle. However, a plurality of substrates are connected by a connector in a conventional camera unit in some cases, and such a camera unit needs a space for mounting the connector to each substrate; thus, it is difficult to downsize the camera unit. The conventional camera unit needs a plurality of components for fixing the plurality of substrates even in a case where the connector is not used for connecting the plurality of substrates, and needs a space for the components (for example, refer to Patent Document 1). For these reasons, it is difficult to downsize the conventional camera unit.

### PRIOR ART DOCUMENTS

### Patent Document(s)

Patent Document 1: Japanese Patent Application Laid-Open No. 2001-275022

### SUMMARY

### Problem to be Solved by the Invention

For example, although a connector is not used for connecting a plurality of substrates in a camera unit illustrated in FIG. 1 in Patent Document 1, a plurality of components such as a front panel, a rear panel, and a top panel are necessary to fix the plurality of substrates, and it is difficult to downsize the camera unit.

The present disclosure is therefore has been made to solve the above problems, and it is an object to provide an in-vehicle camera unit capable of being downsized.

### Means to Solve the Problem

A camera unit according to the present disclosure is a camera unit including a camera taking an image of an occupant of a vehicle, including a rigid flexible substrate and a holder. The rigid flexible substrate is made up of a plurality of substrates connected by a flexible cable. The holder is a single component directly fixing the rigid flexible substrate and an outermost component of the camera unit. The plurality of substrates constituting the rigid flexible substrate include an imaging substrate and a transmission substrate. The imaging substrate mounts a light-receiving element of the camera. The transmission substrate mounts an external output connector for connecting the rigid flexible substrate to an outer part of the camera unit. The holder fixes the imaging substrate and the transmission substrate to be directed to directions different from each other. The light-receiving element and the external output connector are exposed to directions different from each other from the holder while the rigid flexible substrate is fixed to the holder.

### Effects of the Invention

In the camera unit according to the present disclosure, since the plurality of substrates are directly fixed to the holder which is the single component and the outermost component, the plurality of components for fixing the plurality of substrates are unnecessary, and downsizing of the camera unit is achieved. Since the plurality of substrates are fixed to the holder in the state of being directed to the directions different from each other, a dimension of the camera unit in a plan view can be reduced. These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a diagram of a camera unit according to an embodiment 1 disposed in a vehicle.

FIG. 2 is a perspective view of the camera unit according to the embodiment 1 seen from a side of a screen.

FIG. 3 is a perspective view of the camera unit according to the embodiment 1 seen from a side of a cover.

FIG. 4 is an exploded perspective view of the camera unit according to the embodiment 1.

FIG. 5 is a diagram illustrating an unfolded rigid flexible substrate according to the embodiment 1.

FIG. 6 is a diagram of fixation of an image substrate to a holder according to the embodiment 1.

FIG. 7 is a diagram of fixation of a transmission substrate to the holder according to the embodiment 1.

FIG. 8 is a perspective view of a camera unit according to an embodiment 2 seen from a side of a screen.

FIG. 9 is a perspective view of the camera unit according to the embodiment 2 seen from a side of a cover.

FIG. 10 is a perspective view of the camera unit according to the embodiment 2 seen from the side of the cover.

FIG. 11 is a diagram of fixation of an image substrate to a holder according to the embodiment 2.

FIG. 12 is a diagram of fixation of a transmission substrate to the holder according to the embodiment 2.

### DESCRIPTION OF EMBODIMENT(S)

### A. Embodiment 1

FIG. 1 is a diagram illustrating a camera unit 1A according to an embodiment 1 mounted to a vehicle 100. The camera unit 1A is disposed on a front glass or a pillar of a vehicle 100, for example, and is directed to a vehicle interior to take an image of an occupant such as a driver 101 of the vehicle 100. A video taken by the camera unit 1A is outputted to an apparatus (referred to as an external apparatus hereinafter) outside the camera unit 1A, and is used for monitoring that the occupant looks away, dozes, or loses his/her posture, for example.

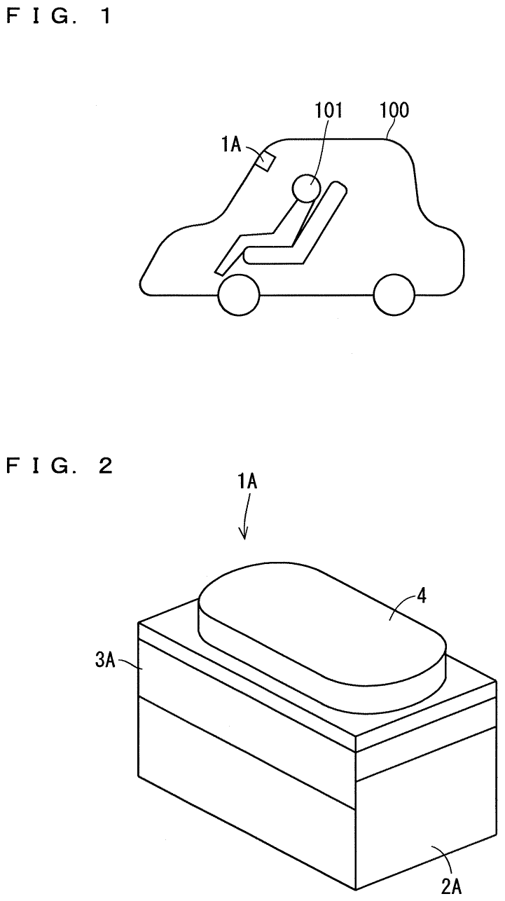

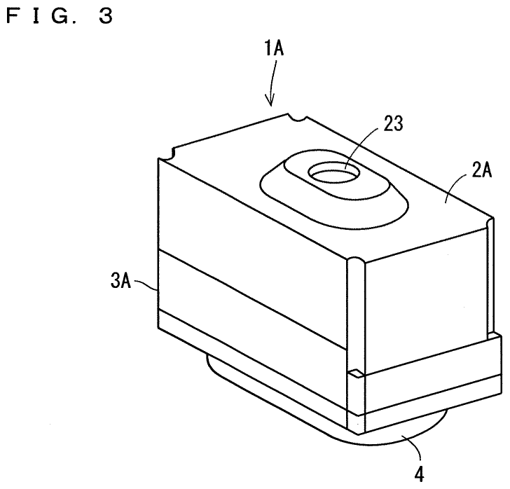

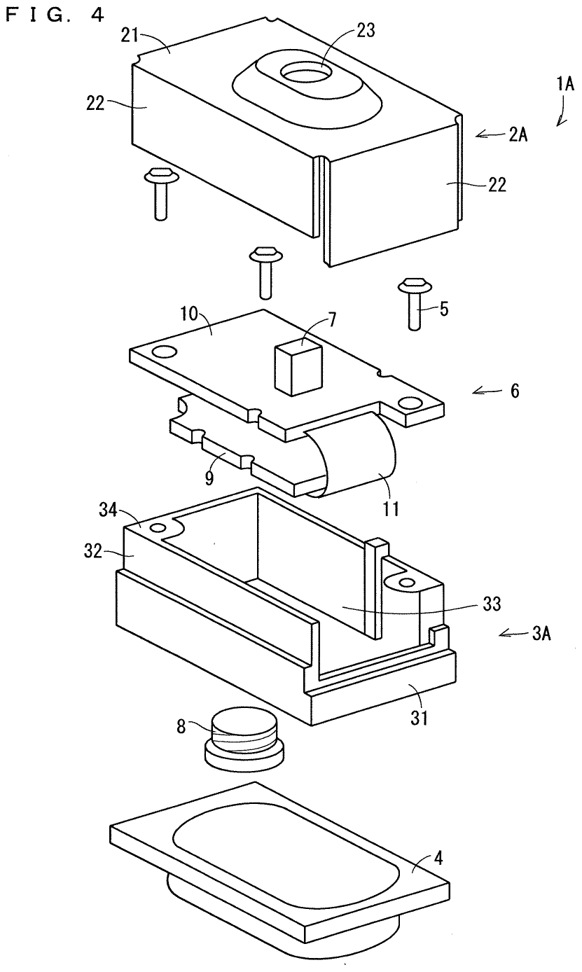

FIG. 2 is a perspective view of the camera unit 1A seen from a side of a screen 4, and FIG. 3 is a perspective view of the camera unit 1A seen from a side of a cover 2A. FIG. 4 is an exploded perspective view of the camera unit 1A.

The camera unit 1A includes a camera taking an image of the occupant of the vehicle and an illumination device illuminating the occupant. However, the illumination device may have a configuration different from the camera unit 1A. The camera unit 1A includes the cover 2A, a holder 3A, the screen 4, a rigid flexible substrate 6, an external output connector 7, and a camera lens 8.

The holder 3A includes a bottom surface part 31 constituting a bottom surface of the holder 3A and a plurality of side surface parts 32 each constituting a side surface of the holder 3A. The plurality of side surface parts 32 are connected to the bottom surface part 31, and are provided substantially perpendicular to the bottom surface part 31. A part of the rigid flexible substrate 6 is housed in an inner space 33 of the holder 3A surrounded by the bottom surface part 31 and the plurality of side surface parts 32. Although the illustration is omitted in FIG. 4, a screw hole is formed in the bottom surface part 31 of the holder 3A. The camera lens 8 is fitted into this screw hole from a lower side in FIG. 4.

The rigid flexible substrate 6 is made up of a plurality of substrates connected by a flexible cable 11. The plurality of substrates constituting the rigid flexible substrate 6 include an imaging substrate 9 and a transmission substrate 10. Since the imaging substrate 9 and the transmission substrate 10 are connected by the flexible cable 11, there is no connector for connecting these substrates.

Although the illustration is omitted in FIG. 4, a light-receiving element of the camera and an illumination device (not shown) are mounted to the imaging substrate 9. When the illumination device has a configuration separated from the camera unit 1A, the imaging substrate 9 does not mount the illumination device.

The external output connector 7 for connecting the rigid flexible substrate 6 to an external apparatus is mounted to the transmission substrate 10. A light-receiving signal of the light-receiving element of the camera mounted to the imaging substrate 9 is transmitted from the external output connector 7 to the external apparatus, and is used for monitoring that the occupant looks away, dozes, or loses his/her posture.

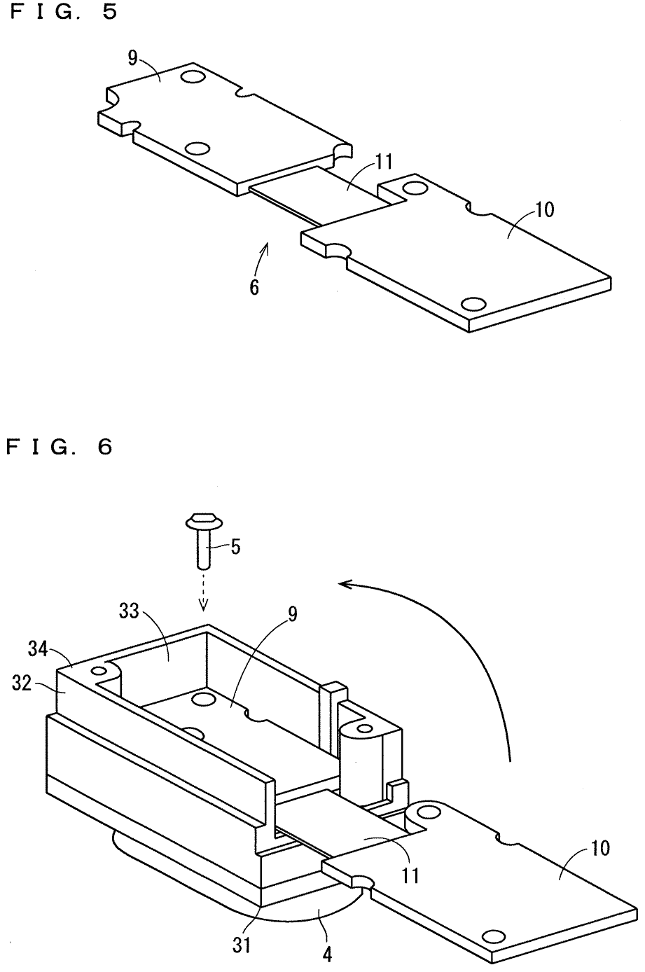

FIG. 4 illustrates a state where the flexible cable 11 is bended and the imaging substrate 9 and the transmission substrate 10 are stacked to each other. In this state, the imaging substrate 9 and the transmission substrate 10 are fixed to the holder 3A by a screw 5. FIG. 5 illustrates a state where the rigid flexible substrate 6 is detached from the holder 3A and the imaging substrate 9 and the transmission substrate 10 are unfolded.

The screen 4 is attached to the bottom surface part 31 of the holder 3A to cover the camera lens 8. The screen 4 is made up of a material through which light passes. Since the screen 4 covers the camera lens 8, the camera lens 8 is protected from damage or dirt.

In the meanwhile, the cover 2A covers an opposite side of the bottom surface part 31 from the holder 3A, that is to say, an upper side in FIG. 4. The cover 2A covers the rigid flexible substrate 6 fixed to the holder 3A. The cover 2A includes a facing surface 21 facing the transmission substrate 10 fixed to the holder 3A and a plurality of side surfaces 22 connected to the facing surface 21. A hole 23 is provided to the facing surface 21 of the cover 2A, and connection between the external output connector 7 and the external apparatus is achieved through this hole 23.

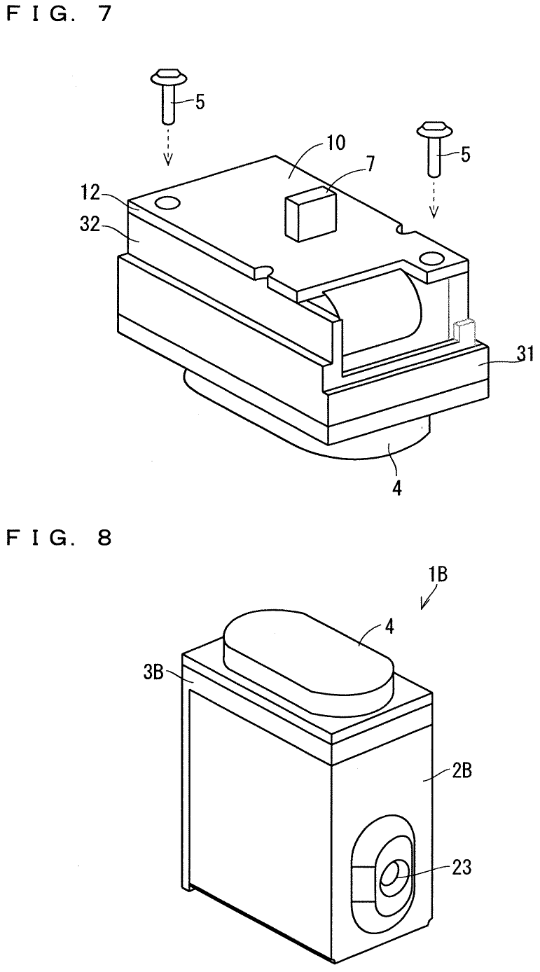

FIG. 6 and FIG. 7 are perspective views each illustrating a procedure of attaching the rigid flexible substrate 6 to the holder 3A.

Firstly, as illustrated in FIG. 6, the imaging substrate 9 is inserted into an inner space 33 in the holder 3A while the rigid flexible substrate 6 is unfolded, and the imaging substrate 9 is fixed to the bottom surface part 31 of the holder 3A by the screw 5. At this time, a fixation direction by the screw 5 is a direction from an upper side to a lower side in FIG. 6. The light-receiving element of the camera and the illumination device mounted to the imaging substrate 9 are exposed from a hole in the bottom surface part 31 of the holder 3A while the imaging substrate 9 is fixed to the holder 3A, and faces the camera lens 8.

Next, the flexible cable 11 is bended, and the transmission substrate 10 is stacked to the imaging substrate 9 and then fixed to an upper end surface 34 of the side surface part 32 of the holder 3A by the screw 5. FIG. 7 illustrates this state. At this time, a fixation direction by the screw 5 is a direction from an upper side to a lower side in FIG. 7. In this manner, the fixation directions in which the imaging substrate 9 and the transmission substrate 10 are fixed to the holder 3A are the directions from the upper side to the lower side in FIG. 6 and FIG. 7, and are the same as each other. Accordingly, the number of operation processes in manufacturing the camera unit 1A can be reduced, and manufacturing cost can be reduced.

When the transmission substrate 10 is fixed to the upper end surface 34 of the side surface part 32 of the holder 3A, an end surface of the transmission substrate 10 is flush with the side surface part 32 of the holder 3A. According to such a configuration, a mounting area of the transmission substrate 10 is maximally ensured while the transmission substrate 10 is fixed to the holder 3A. An area of the transmission substrate 10 can be larger than the imaging substrate 9 housed in the inner space 33 in the holder 3A.

The external output connector 7 mounted to the transmission substrate 10 is exposed from the holder 3A in an upper direction in FIG. 7 while the transmission substrate 10 is fixed to the holder 3A. In the meanwhile, the light-receiving element of the camera and the illumination device mounted to the imaging substrate 9 are exposed from the bottom surface part 31 of the holder 3A in a lower direction in FIG. 7. In this manner, the imaging substrate 9 and the transmission substrate 10 are attached to the holder 3A in the directions different from each other, and accordingly, the external output connector 7 mounted to the transmission substrate 10 and the light-receiving element mounted to the imaging substrate 9, for example, are exposed from the holder 3A in the direction different from each other.

The cover 2A is fitted into the side surface part 32 of the holder 3A while the rigid flexible substrate 6 is fixed to the holder 3A. The cover 2A, the side surface of the bottom surface part 31 of the holder 3A, and the screen 4 are outermost components constituting an outermost of the camera unit 1A.

According to the above configuration, the rigid flexible substrate 6 made up of the plurality of substrates including the imaging substrate 9 and the transmission substrate 10 can be directly fixed to one outermost component of the camera unit 1A, that is the holder 3A. Thus, the camera unit 1A can be made with a small number of components without using a connector for connecting the substrates. Thus, loss of a space caused by fixation of the substrate or a structure of connecting the substrate does not occur, and downsizing can be achieved in the camera unit 1A.

The rigid flexible substrate 6 may include at least one substrate (referred to as an additional substrate hereinafter) in addition to the imaging substrate 9 and the transmission substrate 10. The additional substrate is connected to the imaging substrate 9 and the transmission substrate 10 by the flexible cable 11 at a position between the imaging substrate 9 and the transmission substrate 10. The additional substrate is fixed to the holder 3A while being sandwiched between the imaging substrate 9 and the transmission substrate 10. More specifically, the rigid flexible substrate 6 is folded in the flexible cable 11 so that the imaging substrate 9, the additional substrate, and the transmission substrate 10 are stacked in this order, and is fixed to the holder 3A.

A positional relationship of the imaging substrate 9 and the transmission substrate 10 with respect to the holder 3A may be the reverse of that described above. That is to say, it is applicable that the transmission substrate 10 is fixed to the bottom surface part 31 in the inner space 33 in the holder 3A, and the imaging substrate 9 is fixed to the upper end surface 34 of the side surface part 32 of the holder 3A. Accordingly, the area of the imaging substrate 9 can be larger than that of the transmission substrate 10. In this case, the positional relationship of the cover 2A and the screen 4 with respect to the holder 3A is appropriately changed.

As described above, the camera unit 1A according to the embodiment 1 includes the rigid flexible substrate 6 and the holder 3A. The rigid flexible substrate 6 is made up of the plurality of substrates connected by the flexible cable 11. The holder 3A is a single component directly fixing the rigid flexible substrate 6 and an outermost component of the camera unit 1A. The plurality of substrates constituting the rigid flexible substrate 6 include the imaging substrate 9 and the transmission substrate 10. The imaging substrate 9 mounts the light-receiving element of the camera. The external output connector 7 for connecting the rigid flexible substrate 6 to the outer part of the camera unit 1A is mounted to the transmission substrate 10. The holder 3A fixes the imaging substrate 9 and the transmission substrate 10 to be directed to the directions different from each other. The light-receiving element and the external output connector 7 are exposed to the directions different from each other from the holder 3A while the rigid flexible substrate 6 is fixed to the holder 3A.

Since the imaging substrate 9 and the transmission substrate 10 are fixed to the holder 3A while being directed to the directions different from each other, a dimension of the camera unit 1A in a plan view can be reduced. Accordingly, downsizing of the camera unit 1A is achieved.

The holder 3A fixes the imaging substrate 9 and the transmission substrate 10 in the state of being stacked to each other in the camera unit 1A. Then, the light-receiving element and the external output connector 7 are exposed to the directions opposite to each other from the holder 3A while the rigid flexible substrate 6 is fixed to the holder 3A. According to such a configuration, the imaging substrate 9 and the transmission substrate 10 can be fixed to the holder 3A from the same direction in manufacturing the camera unit 1A. Accordingly, the number of operation processes in manufacturing the camera unit 1A can be reduced, and manufacturing cost can be reduced.

In the camera unit 1A, the holder 3A includes the bottom surface part 31 constituting the bottom surface of the holder 3A and having the hole and the plurality of side surface parts 32 connected to the bottom surface part 31 to constitute the side surface of the holder 3A and form the inner space 33 with the bottom surface part 31. The imaging substrate 9 is fixed to the inner space 33 so that the light-receiving element is exposed from the hole in the bottom surface part 31, and the transmission substrate 10 is mounted to the upper end surface 34 of the plurality of side surface parts 32 so that the external output connector 7 is exposed from the holder 3A. According to such a configuration, the end surface 12 of the transmission substrate 10 can be flush with the side surface part 32 of the holder 3A. Thus, the area of mounting the substrate can be maximally ensured while the transmission substrate 10 is fixed to the holder 3A. The area of the transmission substrate 10 can be larger than that of the imaging substrate 9.

### B. Embodiment 2

In the camera unit 1A according to the embodiment 1, the imaging substrate 9 and the transmission substrate 10 are stacked to each other and fixed to the holder 3A. In contrast, in a camera unit 1B according to the embodiment 2, the imaging substrate 9 and the transmission substrate 10 are disposed to have an L-like shape and fixed to a holder 3B. Also according to such a configuration, the imaging substrate 9 and the transmission substrate 10 are directed to different directions and fixed to the holder 3B; thus, downsizing of the camera unit 1B is achieved.

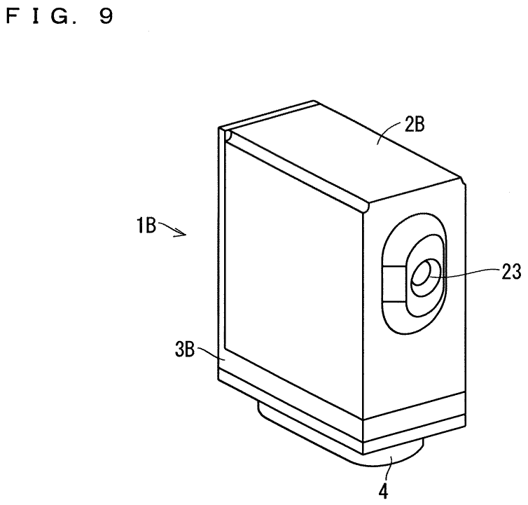

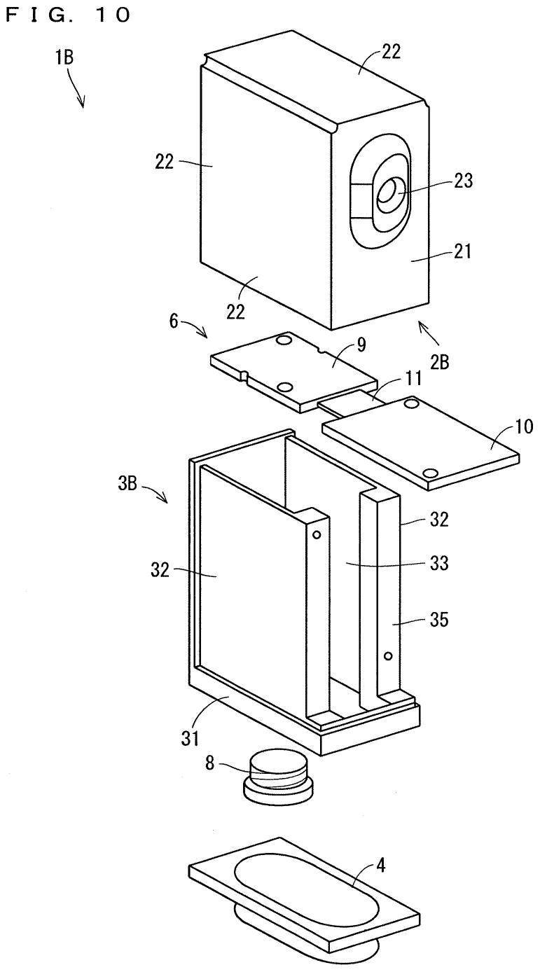

FIG. 8 is a perspective view of the camera unit 1B seen from a side of the screen 4, and FIG. 9 is a perspective view of the camera unit 1B seen from a side of a cover 2B. FIG. 10 is an exploded perspective view of the camera unit 1B.

The camera unit 1B includes the cover 2B, a holder 3B, the screen 4, the rigid flexible substrate 6, the external output connector 7, and the camera lens 8. Since the imaging substrate 9 and the transmission substrate 10 are disposed to have the L-like shape and fixed, a shape of the holder 3B is different from that of the holder 3A according to the embodiment 1. A shape of the cover 2B is also different from that of the cover 2A according to the embodiment 1 in accordance with the holder 3B.

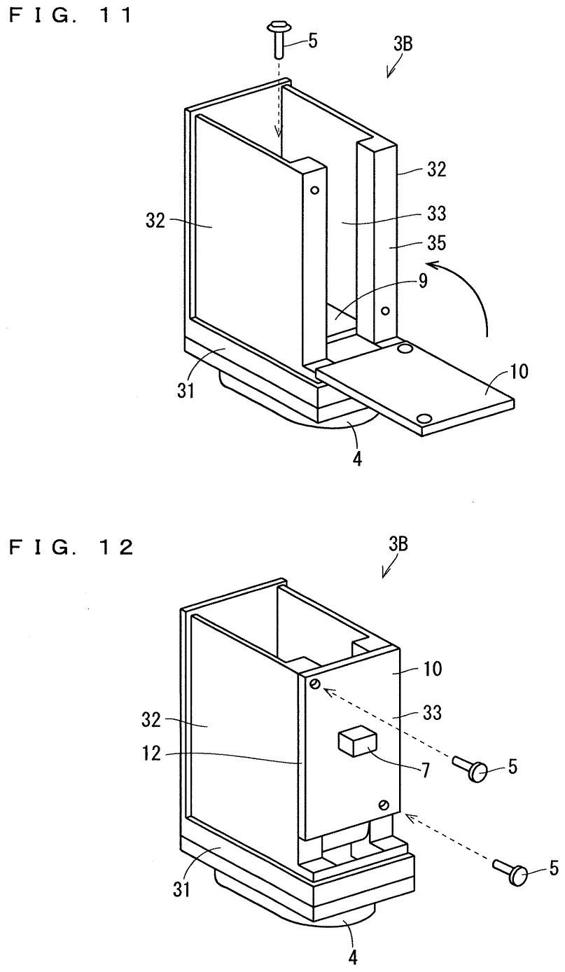

FIG. 11 and FIG. 12 are perspective views each illustrating a procedure of attaching the rigid flexible substrate 6 to the holder 3B.

Firstly, as illustrated in FIG. 11, the imaging substrate 9 is inserted into an inner space 33 in the holder 3B while the rigid flexible substrate 6 is unfolded, and the imaging substrate 9 is fixed to the bottom surface part 31 of the holder 3B by the screw 5. The light-receiving element of the camera and the illumination device mounted to the imaging substrate 9 are exposed from a hole in the bottom surface part 31 of the holder 3B while the imaging substrate 9 is fixed to the holder 3B, and faces the camera lens 8.

Next, the flexible cable 11 is bended, and the transmission substrate 10 is located perpendicular to the imaging substrate 9 and then fixed to a side end surface 35 of the side surface part 32 of the holder 3B by the screw 5. FIG. 12 illustrates this state. In this manner, the imaging substrate 9 and the transmission substrate 10 are fixed to the holder 3B while being disposed to have the L-like shape. Accordingly, a dimension of the camera unit 1B in a plan view is reduced, and downsizing of the camera unit 1B is achieved.

The embodiments can be appropriately deformed and omitted. The foregoing description is in all aspects illustrative. Numerous modifications not exemplified can be devised.

### EXPLANATION OF REFERENCE SIGNS

1A, 1B camera unit, 2A, 2B cover, 3A, 3B holder, 31 bottom surface part, 32 side surface part, 33 inner space, 34 upper end surface, 35 side end surface, 4 screen, 5 screw, 6 rigid flexible substrate, 7 external output connector, 8 camera lens, 9 imaging substrate, 10 transmission substrate, 11 flexible cable.

1. A camera unit including a camera taking an image of an occupant of a vehicle, comprising:
a rigid flexible substrate made up of a plurality of substrates connected by a flexible cable; and
a holder as a single component directly fixing the rigid flexible substrate and an outermost component of the camera unit, wherein
the plurality of substrates include:
an imaging substrate mounting a light-receiving element of the camera; and
a transmission substrate mounting an external output connector for connecting the rigid flexible substrate to an outer part of the camera unit,
the holder fixes the imaging substrate and the transmission substrate to be directed to directions different from each other, and
the light-receiving element and the external output connector are exposed to directions different from each other from the holder while the rigid flexible substrate is fixed to the holder.

2. The camera unit according to claim 1, wherein
the imaging substrate and the transmission substrate are stacked to each other and fixed to the holder, and
the light-receiving element and the external output connector are exposed to directions different from each other from the holder while the rigid flexible substrate is fixed to the holder.

3. The camera unit according to claim 2, wherein
the holder includes:
a bottom surface part constituting a bottom surface of the holder and having a hole; and
a plurality of side surface parts connected to the bottom surface part to constitute a side surface of the holder and form an inner space with the bottom surface part,
the imaging substrate is fixed to the inner space so that the light-receiving element is exposed from the hole in the bottom surface part, and
the transmission substrate is mounted to an end surface of the plurality of side surface parts so that the external output connector is exposed from the holder.

4. The camera unit according to claim 3, wherein
the imaging substrate and the transmission substrate are fixed to the holder from a same direction.

5. The camera unit according to claim 3, wherein
the transmission substrate has a larger area than the imaging substrate.

6. The camera unit according to claim 3, wherein
the transmission substrate is fixed to the holder so that an end surface of the transmission substrate is flush with the plurality of side surface parts.

7. The camera unit according to claim 1, wherein
the imaging substrate and the transmission substrate are disposed to have an L-like shape and fixed to the holder.

8. The camera unit according to claim 2, wherein
the plurality of substrates include at least one additional substrate different from the imaging substrate and the transmission substrate, and
the at least one additional substrate is sandwiched between the imaging substrate and the transmission substrate and fixed to the holder.

9. The camera unit according to claim 1, wherein
a light-receiving signal of the light-receiving element is used for monitoring the occupant regarding the occupant looking away, dozing, or losing his/her posture.
